(19) United States
(12) Patent Application Publication
(10) Pub. No.: US 2006/0265626 A1
(43) Pub. Date: Nov. 23, 2006

(54) Method for dynamic reprogramming dataflow in a distributed system

(75) Inventors: Kristinn R. Thorisson, Raykjavik (IS); Thor List, Edinburgh (GB); Christopher C. Pennock, NewHaven, CT (US); John J. DiPirro, Bronx, NY (US)

Correspondence Address: Rupak Nag, Suite 1210, 2170 Century Park East, Los Angeles, CA, 90067, US

(73) Assignee: Communicative Machines, Inc.

(21) Appl. No.: 11/134,839

(22) Filed: May 21, 2005

(51) Int. Cl. G06F 11/00

(52) U.S. Cl. 714/12

(57) ABSTRACT

A software tool or framework for designing a software architecture is described. The tool consists of three broad components: a series of data channels, multiple global states, and a software architecture maintainer which performs as a scheduler and “switchboard” for the architecture. The architecture maintainer communicates with modules in a collection of modules using the multiple data channels and also stores global states data. The tool is configured such that a module only receives data via a data channel for which the module has registered. A module will not receive data on a data channel, nor will the maintainer send data on a data channel, for which the module is not registered. The module also has one or more relevant global states. The software tool of the present invention enables modification of the behavior of a module during the runtime of the module.

### PRIORITY CLAIM

The present invention claims priority to U.S. Provisional Patent Application No. 60/546,794 filed on May 21, 2004.

### BACKGROUND OF THE INVENTION

1. Field of the Invention

The present invention relates to computer software applications. More specifically, it relates to software enabling improved construction and management of modular systems, and communication among software entities in such systems.

2. Introduction

With the price of computing power and network access dropping, the size of the software systems built is generally increasing. Large systems with many processes are notoriously hard to design, develop and monitor. Many methods have been employed to make the creation and maintenance of software systems more manageable. To simplify the task, and as a result limit their scope and generality, the methods and tools for creating and managing such systems have used various background assumptions about their use. As a result, most of them can be classified along four dimensions based on their assumptions about (a) the number and nature of the processes, (b) coordination mechanisms employed, (c) network and communication, and (d) management style and visualization options that the system offers.

With regards to the first dimension, a software architecture is needed to relate to systems where the processes are functionally distinct and can therefore be implemented as semi-independent, self-contained entities, or “modules”. In Semantic Web systems the number of processes is assumed to be extremely large and largely unknown. The Semantic Web effort revolves around making processes on the Internet and World Wide Web more aware of the types of information they handle and be more autonomous. To enable this, processes have to be equipped with sophisticated communication capabilities including explicit message semantics and robust communication protocols. In systems to date solutions to these problems have tended to be overly complicated and opaque, partly because they have to include solutions to how these processes, which are unknown to each other, can discover each other. Many proposals exist for these problems. No clear winner has yet emerged.

At the smaller scale are issues related to the creation and management of software programs that run on a single computer or in a simple client-server situation. The object-oriented metaphor has proven to be a relatively good solution to this. Another solution that has been helpful here are so-called software threads, which enable parts of a program to run independently of the rest of the system in which they are embedded.

However, few tools and methods exist that address systems that lie between these two extremes, that is, systems that comprise a number of processes and process complexity that is larger than standard applications but smaller than the World Wide Web. Those that do are often lacking in the kinds of visualization capabilities they support.

Turning to the second assumption about coordination mechanisms, most architectures use some kind of formalized control, either in the form of a global controller or smaller local controllers linked in a hierarchy. This is usually needed to do intelligent routing of dataflow and changing process parameters, etc. However, in many architectures, e.g. an architecture built to simulate human thought processes, this assumption cannot be made; these systems must be possible to build without any specific built-in control. Data and process flow need to be recalculated and changed instantly by the system based on the information obtained about each individual process itself. This calls for a system that is completely free of any kind of assumptions about the design of the control system.

Interaction coordination mechanisms have been largely two types: message-oriented and object-oriented. CORBA and DCOM are examples of the latter. CORBA solves at least two major problems. First, it bridges different programming languages. Secondly, it allows systems on separate computers to act as if they were a single program. To do this, CORBA uses a mechanism called remote method invocation (RMI) that allows one process, or program, to call methods in another program. Most RMI implementations block on each call, that is, when calling a method in another program the program stops operating until the method call returns a value back. This means that the calling program cannot do anything other than wait for the return value. This is a problem for systems that have to operate in real-time, i.e. that have to respond to various inputs while running (other than the remote method call). Another problem is that keeping track of time during these remote procedure calls is complicated to do because a general solution for this is not built into the system. A third problem with systems such as CORBA is their high degree of complexity. In some cases a fourth problem is the size of the system, which can grow to many megabytes, preventing operation on small devices such as hand-held computers and mobile phones.

Message-oriented solutions do not have the problem of blocking. Among systems that have employed message-oriented coordination are many of the Semantic Web applications, which cannot know how long it takes for a request to be answered. However, these systems lack in how they make the temporal events in the system explicit to the designer and to the system itself. Typically the systems ignore time altogether, or represent time in very simplified ways.

A rigorous message and transmission routing specification could be used to addresses all three of the above problems. That is, the multiple programming language problem, the blocking problem and the temporal representation problem. Although it is possible that such a specification exists today, it has not been integrated into a useful and flexible system.

With regards to the assumptions about the network and communication characteristics, Semantic Web solutions assume very unreliable network connections between modules. Other solutions, such as client-server based database networks, assume very stable, unproblematic networks. A third group of solutions assumes mobile client reception nodes, which carries with it even more problems. Few solutions have revolved around the intermediate stage, where many of the network connections may be stable, but a few, possibly well-documented and isolated connections may be mobile and/or unstable. Such a situation calls for a heterogeneous solutions where the systems designer is allowed to set the system up in a way that takes advantage of the known factors in the topology.

No system exists at present that makes it possible to enable communication between very different systems, for example, a vision system and a speech recognition system; such systems are designed too specifically to certain categories of problems for prior frameworks to address. A solution to this would be highly valuable, especially for integration of systems that are intended to simulate some aspect of human intelligence. In fact, it should be possible to implement and integrate a large number of very different technologies, hook up several otherwise incompatible systems, and allow them to communicate. Frameworks or tools that assume such a set of highly heterogeneous software technologies do not exist today.

Turning to the assumption about visualization and management style that the system offers, many systems with static routing paths between modules have been outfitted with visualization and monitoring capabilities. Typically these allow the human operator to see the status of a single module or details of one module at a time, often in the form of a static image—a “snapshot”. In these systems, what makes the monitoring and visualization possible is the fact that they have static or semi-static routing tables between the modules. What has been missing is the ability to visualize systems with highly dynamic routing between modules, that is, where the data routes between the modules keeps changing at runtime. Further, the ability to dynamically switch on and off semantically related groups of modules has also been missing in prior systems. Lastly, they have been unable to allow such control to be done dynamically from a remote location.

A visualization tool for monitoring every part of the system would be extremely helpful. It would need to allow monitoring and interaction with all aspects of a system, from global states down to the content of individual messages and multimedia streams in info channels.

The most challenging aspect about designing a system comprised of multiple modules is the increase in complexity. This complexity has numerous consequences. Typically the solutions proposed have been slow, bloated, highly targeted to a specialized problem, or been significantly deficient in one way or another. As of yet, no general solution exists that provides centralized management and monitoring, allows the designer direct interaction with the system, minimizes problems associated with time delays (or at least allows them to be explicitly known via timestamps), enables combining discrete messages with streaming data in a unified way, and, last but not least, has a low degree of complexity from the user's point of view.

Therefore, what is needed is a system for managing large numbers of processes that is simple to use yet is powerful and generic enough to apply to a large set of problems. The system should allow the user to mix discrete and streaming data with ease and there should be explicit handling of time throughout the system.

What is also needed is a system to treat discrete and streaming data in as similar a manner as possible, in terms of how a module subscribes to the data, queries the system for the data and reads the data from the system.

What is also needed is a system that enables easy integration of heterogeneous systems, with different data types and data requirements, written in different languages, and running on different computers. The invention should offer a stable and simple protocol for communication, and to enable heterogeneous systems to easily implement the protocols.

What is also needed is a system that offers visualization of, management of, and interaction with, individual processes and groups of processes. A human operator should be able to add processes to and remove processes from the system dynamically (during runtime) and alter the running system by introducing new data and new states at any time.

What is also needed is a system that allows a system designer to make few assumptions about control, data flow or processing, and allow the designer of the system to determine the details of these aspects.

### SUMMARY OF THE INVENTION

In one aspect of the present invention a software tool or framework for designing a software architecture is described. The tool consists of three broad components: a series of data channels, multiple global states, and a software architecture maintainer which performs as a scheduler and “switchboard” for the architecture. The architecture maintainer communicates with modules in a collection of modules using the multiple data channels and also stores global states data. The tool is configured such that a module only receives data via a data channel for which the module has registered. A module will not receive data on a data channel, nor will the maintainer send data on a data channel, for which the module is not registered. The module also has one or more relevant global states. The software tool of the present invention enables modification of the behavior of a module during the runtime of the module.

In another aspect of the present invention, a method of executing a process or module in a software architecture is described. A process in the software architecture subscribes with a system architecture maintainer. The process informs the maintainer of one or more relevant global states and one or more named data channels. The process receives data from the system architecture maintainer only on a named data channel and performs executable tasks independent of the system architecture maintainer.

In another aspect of the present invention, a method of managing a software architecture is described. A maintainer, or a scheduler/switchboard, of the software architecture, maintains a set of data relating to multiple global states. It also maintains a second set of data on the validity of each global state in the software architecture. The maintainer receives an instruction or message from a module in the architecture, where the instruction relates to an executable task to be performed by the module. This executable task follows a previous executable task of the module. The maintainer also maintains another set of data that contains the global state or states relevant to the module and data relating to at least one data channel that the module registered or subscribed to with the maintainer.

### BRIEF DESCRIPTION OF THE DRAWINGS

The invention will be better understood by reference to the following description taken in conjunction with the accompanying drawings in which:

FIG. 1 shows the method of dynamic reprogramming of a distributed system.

FIG. 2 shows a registration being accepted by a central scheduler; the scheduler holding a single global state.

FIG. 3 shows a central scheduler holding multiple global states where only one of them is valid and the origination, reception and transmission of data in the architecture.

FIG. 4 shows a registration that includes more than one global state/information channel pair.

FIG. 5 shows data being originated by a process, received by a central scheduler and transmitted to another process.

FIG. 6 shows a hierarchical tree-structure definition of global states and information channel names.

FIG. 7 shows part of the method of dynamic reprogramming of a distributed system over a data network, in accordance with one embodiment of the present invention.

FIG. 8 shows the components of a process, its performable tasks and the grouping of tasks into groups such that each task belongs to a particular global state.

FIG. 9 shows a process originating a message containing a specification of a valid global state that modifies a hierarchical global state that was valid before.

FIG. 10 shows a process originating a message containing a specification of a new valid global state that did not exist before.

FIG. 11 shows central scheduler information monitoring, including data about modules and messages.

FIG. 12 shows a whiteboard/scheduler.

FIG. 13 shows a whiteboard/scheduler with details.

FIG. 14 shows the ‘post message’ and ‘post context/global state’ interface.

FIG. 15 shows the contexts/global states and phases/executable tasks information.

FIG. 16 shows data being originated and received by a scheduler, wrapped in another “wrapper” and transmitted to a subscribed module.

### DETAILED DESCRIPTION OF THE INVENTION

While specific implementations of the present invention are discussed, it should be understood that this is done for illustration purposes only. A person skilled in the relevant art will recognize that other components and configurations may be used without parting from the scope of the invention.

The invention involves enabling processes within a collection of processes to efficiently communicate with each other, in an architecture where data requirements are dynamically changing in complex ways and thus the transmissions and connections between the processes need to be changing dynamically during runtime. The processes may be running on a single computing device or distributed over a plurality of such devices. In a preferred embodiment, a process is an executable program.

Each process, or processing entity, also called module, has at least one executable task. For each module at least one global state is specified; typically there are many global states specified for a single module.

Global states are used throughout the system to synchronize modules. Modules that specify a particular global state will be ‘active’ during the period in which the global state is valid, but not while other (incompatible) global states are valid. Being active means that data can be transmitted to that module by a scheduler, should it appear on a channel that is listed in that module's registration. If any one of the module's global states is valid in an architecture, as explained below, then the module is free to receive data on an information channel for which it has been registered. One can think of each global state as specifying a particular situation or Boolean condition when data on a particular channel, as specified in a module's registration request, should be transmitted to that module. The global state acts as a “valve” to the flow of data to modules: When the state is valid the valve is “open”. Thus, a module will not receive data that appears on an information channel unless at least one global state currently associated with the module is also valid (the information channel on which the data appears also needs to be associated with the global state, as explained below).

Any module can change a global state from valid to invalid and vice versa at runtime. A module can do this by originating a message to a central scheduler to that effect. A human user can do so as well. In one embodiment changes to global states are originated on an information channel called GLOBAL.STATE. A module will thus receive data from an information channel if

(a) the module registered for that channel and a specific global state and

(b) that global state is the currently active global state and

(c) information exists on that channel

Further:

(d) there can be multiple valid global states at the same time in the architecture

(e) a module can change or add a new active global state, which can also be done manually

(f) a module can specify multiple states in its registration

Global states relevant for a module, the information channels it is interested in, and its executable task(s), are registered with a central scheduler. This registration can be done all at once or incrementally. It can be done at startup and at any time during runtime. Registration requests must always specify a particular module to which the registration applies, at least one global state for the module and at least one information channel. The executable tasks are named; the names are unique within each module and are associated with each module. Since each module has a unique name the scheduler can know which executable tasks belong to which module, even if an executable task in one module is tagged by the same identifier as an executable task in another module.

During runtime, registrations are thus held by one or more central schedulers. Registration requests relevant to any module can be specified in a configuration file or data store that is read by the scheduler when the architecture is started, or during runtime (after startup). The module to which a registration request applies can also itself send it to a scheduler; a scheduler can thus receive registration requests from any process, even a human user, during runtime or at startup.

If data appears on an information channel, that data is immediately scheduled for transmission to any module that has requested registration for data on that information channel, but only if the global state specified for the module is currently valid, as explained above.

There are two main ways of specifying a registration to a scheduler: full and partial. In both cases, the registration request includes the name of the module, all global states relevant to the module, at least one information channel and at least one executable task. The registration is partial when the module has more executable tasks and/or more information channels that it may be registering for in the future. We will now explain the partial registration process further. Typically, the executable task is grouped under one of the global states, e.g. {M1 {GS1 {Ch1, ET1}}}, where M1 is the module name, GS1 is the name of a global state, Ch1 is an information channel, and ET1 is an executable task. So in this example the channel Ch1 and executable task ET1 are listed under the global state GS1. Immediately following the reception of this registration request during runtime, a scheduler will transmit any data appearing on Ch1 to module M1 if the global state GS1 is valid at that point in time. When transmitting this data to M1 the scheduler will use the same channel that the data came in on. The scheduler will do this by putting the data inside a new ‘wrapper’ or ‘envelope’ and mark it with the same channel (this step is important with regards to the timestamps used to track the transmission events related to the data, as explained below). Upon receiving the transmitted data, module M1 will perform executable task ET1. This task may be composed of an initial Boolean test for deciding whether to process the data further, a data processing step which is performed if the initial Boolean test returns true, and a final Boolean test which determines whether the module should originate data based on the result of the data process.

We will now take another example where the registration is slightly different. The registration can include two sets of channel/executable state pairs, {Ch, ET}, under the same global state, e.g. {M1 {GS1 {Ch1, ET1} {Ch2, ET2}}}. Sets are mutually exclusive so in this case the module has a choice of using either the first set {Ch1, ET1} or the second set {Ch2, ET2} when global state GS1 is valid in the architecture. The decision of which set to use is made by the module. If the module decides to switch from the first set to the second set, which usually happens directly following the decision to either originate data or not, it will notify a scheduler of this decision. In the case where the module decides to originate data, this decision can be included with the originated data. If the module decides to not originate data, but wants to switch to the second set, it will notify the scheduler with a message. Additionally, the module can at any time during runtime decide to switch to the second set.

In a preferred embodiment, the executable tasks are always chosen and done in a fixed order. That is, the order of selection and execution of the executable tasks is sequential. When this is the case, the order loops back to the first executable task when the last task has been abandoned. In the case of fixed order of executables, instead of a partial registration, a complete registration is possible: A complete registration includes the full set of global states, channels and executable tasks that the module will ever need during its lifetime. Furthermore, in this case, the decision to switch to another set is simply indicated to a scheduler with a (semantically tagged) Boolean value. This is important for efficiency reasons: No additional communication is needed from the module to the scheduler to reprogram the flow of data to itself. Upon receiving data on an information channel the module can thus:

(a) decide to originate data or not, and

(b) decide whether to switch to the next executable task or not.

Multiple channels can be listed for each executable task, e.g. {M1 {GS1 {Ch1, Ch2, ET1} {Ch2, Ch3, ET2}}}. Multiple global states can be listed in a registration request, e.g. {M1 {GS1 {Ch1, Ch2, ET1}{Ch2, ET2}}{GS2 {Ch1, ET1}{Ch2, ET3}}}. It is not necessary that either the channels or executable tasks are unique in each set; in this example Ch2 is listed for ET1, ET2 and ET3. The same can be said for the global states: The same executable task can appear in all sets. (For practical reasons, though, it is unlikely that one would specify a registration where all the values are the same.)

Global states are hierarchical, organized from general to specific. To take an example, the global state ‘Earth’ is more general than the global state ‘Northpole’, and the former state is implied by the latter state (if we are on the Northpole we are by default on Earth). Thus, the global state for Northpole can be denoted ‘Earth.Northpole’, where ‘Earth’ designates the most general global state. If at some point in time during runtime of the architecture, the state Earth.Northpole is valid, and the state ‘Earth.Equator’ is originated, it means that Earth.Equator is now valid. Furthermore, because the two states share a root, that is, the root ‘Earth’, the state Earth.NorthPole is now no longer globally valid—it is invalid. Any module whose registration request specified Earth.Northpole will now cease to be ‘active’. However, because of the hierarchical nature of global states, and because registrations can specify pattern matching, if a module has registered for ‘Earth.*’, that module remains active because the root in its global state is still included in ‘Earth.Equator’.

Upon receiving data over a subscribed-to information channel, a module can request to receive data over at least one additional information channel. In a preferred embodiment, this additional information channel or channels have already been specified in the registration request. To take an example, the registration request {M1 {GS1 {Ch1, R:Ch2, ET1}}} specifies that whenever data appears on Ch1 it should be transmitted to module M1, but along with it data on information channel Ch2 should also be included (“R:” stands for “retrieval”). Data on channels marked with ‘R:’ are not transmitted to modules unless data appears on at least one channel that is not marked in that way. One way to think of it is that “R:” means “attachments”, to use an email analogy.

The additional information channel(s) can also can be requested by the module during runtime, dynamically as needed, i.e., “on-the-fly.” These dynamic types of requests can happen at any time during the operation of the module or they can happen upon reception of a particular piece of data. For such an additional request, the module must identify itself and specify at least one information channel. Additionally the module can specify further restrictions, such as temporal restrictions (e.g. “only data that was produced after 12 noon”) or there can be other restrictions, for example on the module that produced the data. In the current implementation, when the module receives a particular data, the module is also handed a set of additional data if its registration request has specified that additional data be received. The module can then choose to do whatever it wants with the additional data.

Data that is originated by a module and sent to a scheduler is timestamped when it leaves the module and timestamped when it is received by the scheduler. When that data is transmitted to the modules that have registered for the channel on which that data appears, it is ‘wrapped’ or ‘re-packaged’, as mentioned above. When it leaves the scheduler, the new wrapper package is given a timestamp. Upon reception in a module the data is timestamped again. All timestamps are based on a global clock; all timestamps indicate the global time when the stamp was made. Thus, any path for any data, from one module via the scheduler to another module, has four timestamps. Based on these timestamps, the global characteristics of each step in the process of getting one set of data from one process or module to another can be calculated.

The scheduler and the modules use priorities in a novel yet straightforward way. There are three priority types: a message priority, a processing priority, and a channel priority. The message priority determines in which order messages are delivered to modules when the system is busy. The processing priority gives a separate measure of the computation priority, once the message has been delivered to a module. Each scheduler also has a channel priority which determines which data channel has a higher priority. These priorities can be dynamically monitored centrally for all parts of the system, and modified, from a remote location (see description of monitoring tool below).

Both streaming media and messages can be freely mixed within a single scheduler. As with messages, streaming media can be accessed by registration, or by dynamic requests. Both of these data types are accessed in the same manner.

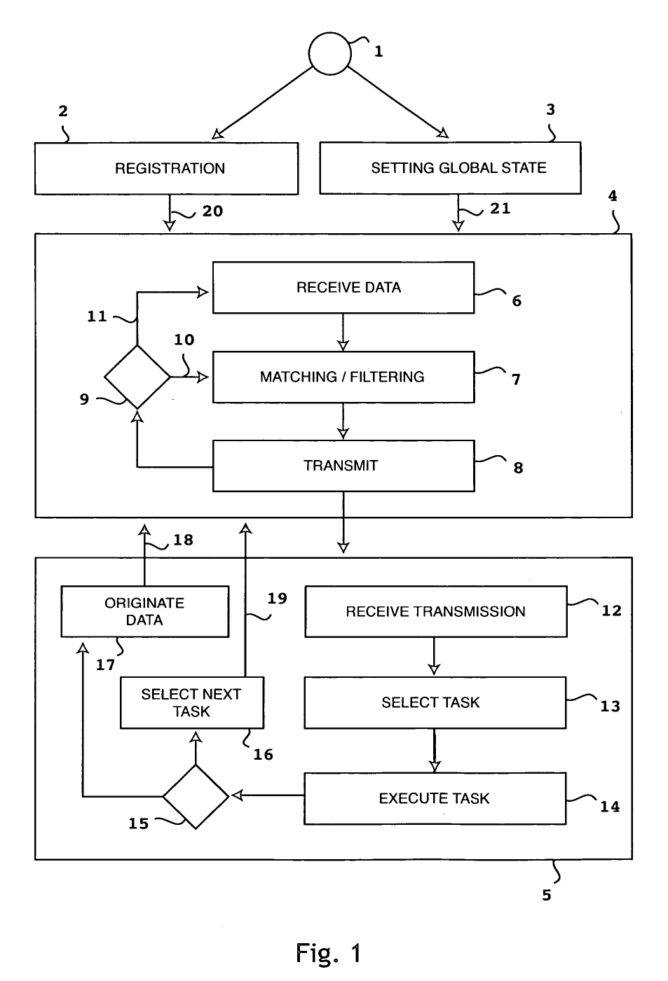

Referring to FIG. 1, at the start of a system 1 one or more registrations 2 need to be requested and one or more global states 3 need to be set. These are maintained by a scheduler 4. When a scheduler is ready to receive data it is in state 6.

Upon reception of any data 6 the scheduler compares 7 the information channel of the incoming data to the information channels listed in the registrations 20 it has received, as well as the current global states that have been set 21. The comparison may be a simple string comparison or it can be a more complex filtering (see below). If the comparison returns a match for a registration, the received data is transmitted 8 to the module listed in the registration. After a transmission a decision is made 9 whether to do more matches 10 or to check the next received data 11 (the scheduler is able to receive data at any time, even during the other stages of processing received data). The module 5 is always in a state of reception 12. When it receives data it goes to either select a task, if none was selected before 13, or it selects the task to execute that was selected last time the module received data. It then executes the task 14. Once executed the module needs to decide 15 whether to originate data 17 and whether to select a different task 16. If it decides to originate data it transmits this data to a scheduler 18. If it decided to select a different task it will transmit this information with the data 18. However, if it does not originate data but wants to select a different next task it will transmit just this information to a scheduler 19.

Once data has been transmitted 6 it is received 7 by a module, which can subsequently select a task to perform 7. The selection of a task to perform may have been determined beforehand or it may be determined based on the data received. Once it is clear which task is to be executed, the module will execute the selected task 8.

Based on the outcome of the execution of the task, the module may decide which task to perform next 9. At this point in the procedure there is a choice 11 of (a) going to a step 12 where a global state can be set 2 and/or a registration can be received 3, or (b) receiving another set of data 4.

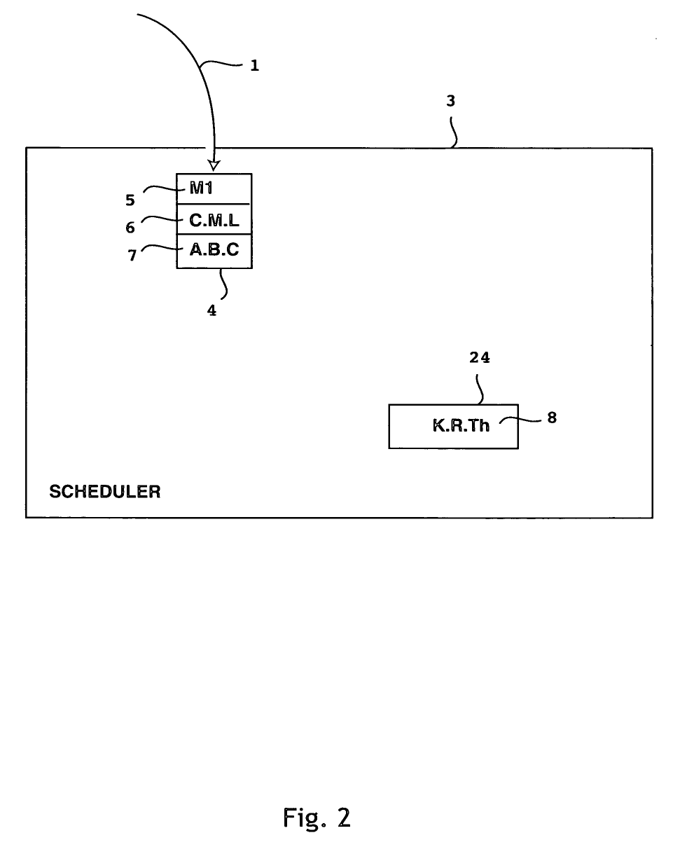

Referring to FIG. 2 a registration request 4 is received 1 by a scheduler 3. The registration can come from any process, module, disk location or network connection. The registration contains information that identifies the registrant (the module that this registration request applies to) 5, a global state 6, and an information channel 7. The scheduler has, in this illustration, a state 8, which is stored in a memory location 24.

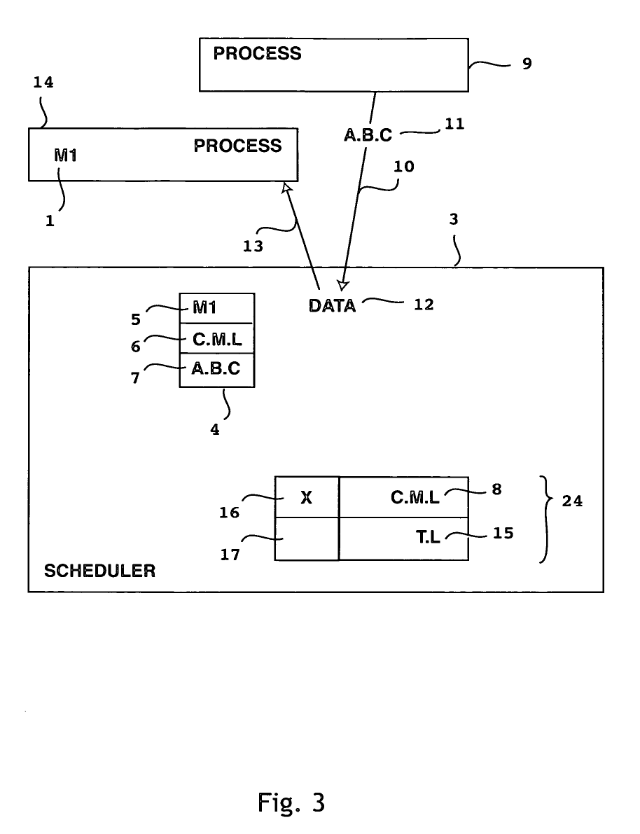

Referring to FIG. 3, a scheduler 3 contains multiple global states 8, 15, in its global states memory 24. One of these states 8 is marked as being valid 16; the other is marked as being not valid 17. The scheduler also has a registration request 4 for a module M1 5, 14. Another module 9 originates data 12 that the scheduler receives 10. The data is sent via information channel A.B.C 11. Upon receiving the data the scheduler will compare the information channel 11 of the data to its registration requests. In this case the data's information channel 11 matches the information channel 7 listed in the registration request 4.

Next the scheduler will compare the global state 6 listed in the information request 4 to the global states listed in its state memory 24 to see if the state is currently valid. Since state 8 is currently valid 16, the data 12 is now transmitted 13 to the module 5, 14, indicated in the registration request. In one embodiment of the invention, the hierarchical definition of global states would enable a match of a global state C.M specified in a registration request to match with a global state C.M.L listed as valid in the state memory 24. This is because C.M.L is more specific than C.M—if C.M.L is a valid state then C.M is automatically valid.

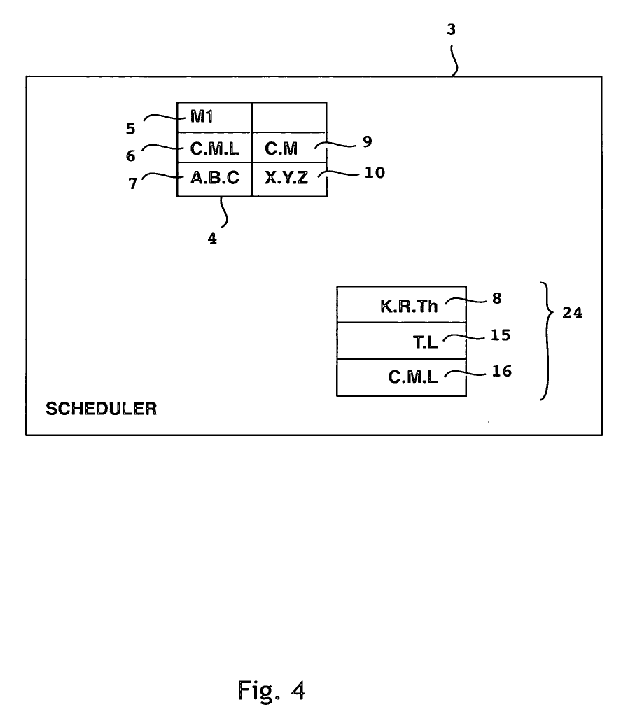

Referring to FIG. 4, a registration request 4 referring to a single registering module 5 contains two global state and information channel pairs, one pair being the global state C.M.L 6 and information channel A.B.C 7, the other being global state C.M 9 and information channel X.Y.Z 10.

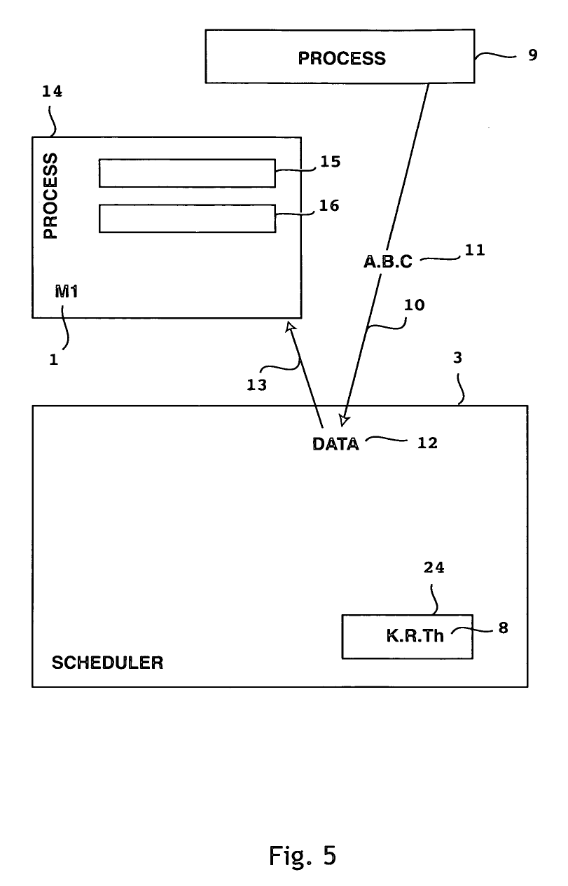

Referring to FIG. 5, a module (process) 14 named M1 1 contains two performable (executable) tasks 15, 16. Another module 9 originates data 12 which it provides 10 to a scheduler 3 on information channel A.B.C 11. Using its matching process (see below) it will transmit 13 data 12 to module 14, which, upon receiving data 12, the scheduler selects one of its two performable tasks 15, 16 to execute.

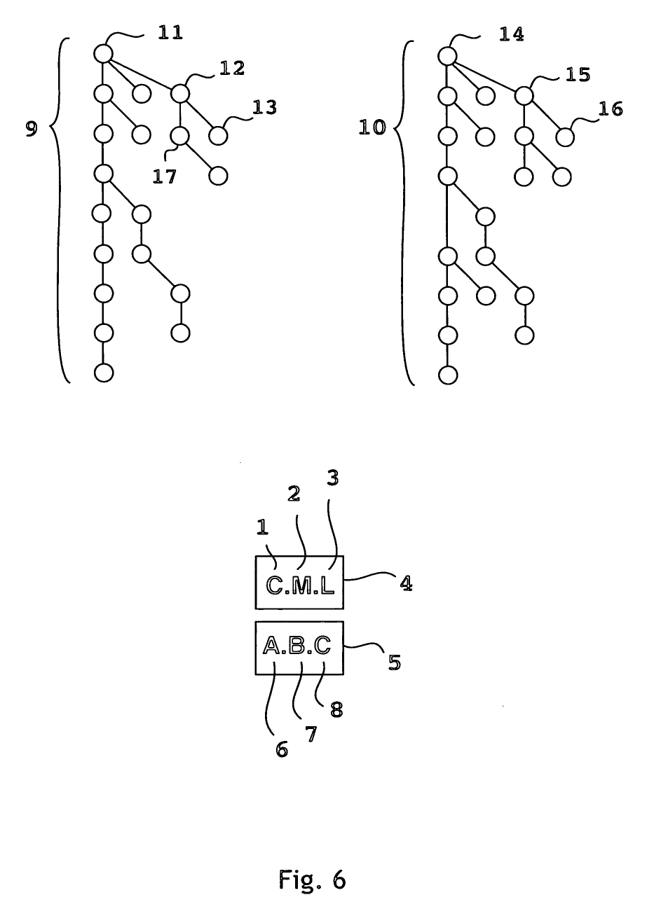

Referring to FIG. 6, a global state 4 and an information channel 5 are defined in hierarchical taxonomies or ontologies 9, 10. Referring to the global state 4, its first element 1, also called a root, is defined as the top node 11 in a tree 9 its second element 2 is defined as a branch 12 off the top node 11. Its third element 13 is defined as a branch off the second branch 12. Referring to the information channel 5, its first element 6 is defined as the top node 14 in a tree 10; its second element 7 is defined as a particular branch 15 off the top node 14; its third element is a branch 16 off the second node 15.

In one embodiment of the invention the hierarchy defines a typical inheritance tree. To take an example from driving an automobile with automatic gearshift, the top node represents the motor running, the second state represents the brake being sufficiently pressed down, and the third being the gear stick being in position “drive”. All branches in such a tree are assumed mutually exclusive. In the automobile example, node 17 could represent the gear stick being in position “park”; in other words, global state 11/12/13, which corresponds to C.M.L in FIG. 6. This state could not co-exist with 11/12/17, because the gears could not be in position “drive” and “park” at the same time. In a software system for simulating a person driving a car, some of the modules would involve decision making that would lead to the gears being shifted from “park” to “drive”. The change could then be reflected in the global state of the system.

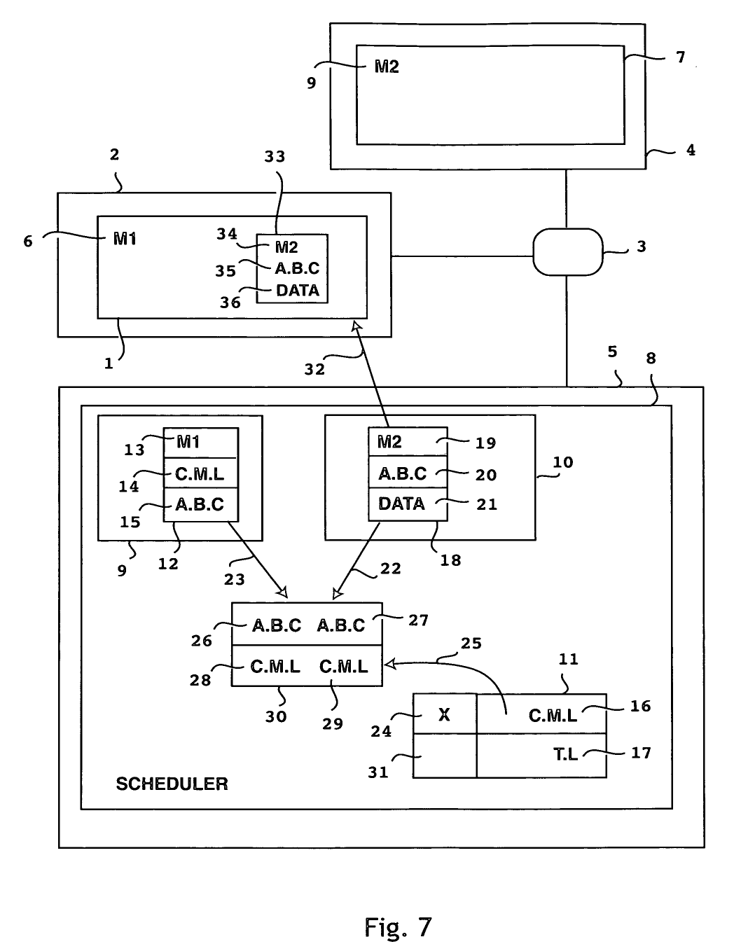

FIG. 7 shows further detail in which three computing devices 2, 4, 5, are connected over a data network via a router 3. Computing device 2 runs a process named M1 6 (module 1), computing device 4 runs another process named M2 9 (module 7), and computing device 5 runs a scheduler 8. Module M2 7 originates data 18 which is received by the scheduler 8 into its data storage memory 10. Data 21 identifies the originator M2 19, the information channel of the data 20, as well as the data 21. The scheduler currently has one registration request 12 in its registration request memory 9. Upon reception of data 18 from process 7 running on computer 4, the scheduler compares A.B.C information channel of the data 20 to the information channel 15 listed in the registration request 12. They match 26, 27, because they are identical.

Next the scheduler selects valid global states 25. The only valid 24 global state is C.M.L 16. The scheduler selects 25 the valid state C.M.L to compare 29 to the global state 28 listed in the registration request 14. They match 28, 29 because they are identical. The two conditions for transmitting data to a module are now both met and the scheduler 8 can transmit 32 the data 18 to the module 1 identified 13 in the registration request 12. The module then receives the data 33. Along with the received data there is an indicator showing the originator of the data 34, the information channel from which the data was originated, and the data itself 36.

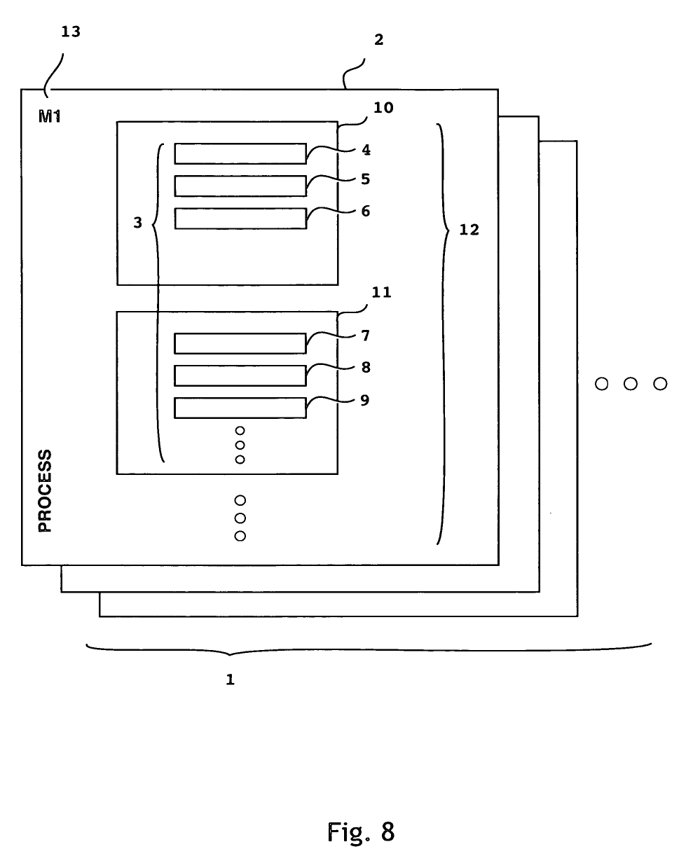

Referring to FIG. 8, a collection of processes/modules 1 are depicted. The structure of process 2 is shown in detail 3, 12, 4-11. The process' name 13 is unique within the architecture. The process has a set of global states 12, two of which are illustrated in further detail 10, 11. Global states 12 group together a set of performable tasks 3.

Referring to grouping 10, performable tasks 4, 5, 6 “belong to” a particular global state. This means that if the global state listed for grouping 10 is valid and the one listed for grouping 11 is not valid, only performable tasks 4, 5 or 6 can be selected amongst the next tasks to perform. This applies in the case where global states are mutually exclusive. For cases where the global states listed for groupings 10 and 11 are not mutually exclusive, the pairing in the registration request for module 2 will determine which global state is relevant for any transmitted data, and thus from which performable tasks the module is permitted to choose.

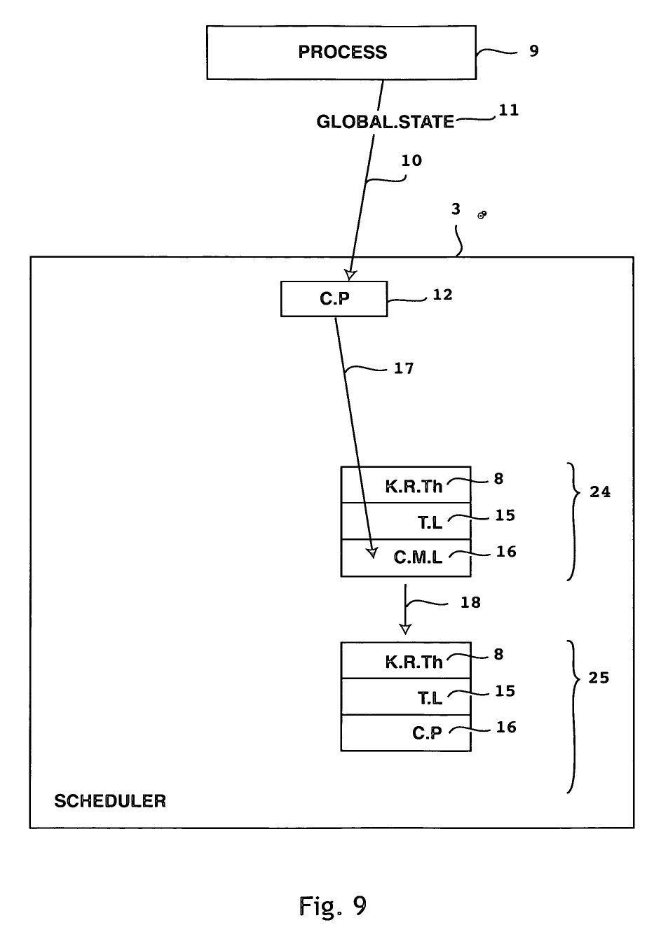

Referring to FIG. 9, the modification of an existing global state is depicted. A process 9 makes available 10 data 12 to the scheduler 3 which specifies a state C.P that should be valid. In one embodiment the information channel for such data is called GLOBALSTATE. Upon receiving the data from the process, the scheduler compares the newly received valid state 12 to the state table in its state memory 24. The scheduler identifies one state C.M.L 16 which has a root C identical to the newly received state 12. Thus, branches M.L of C.M.L are now invalidated. The scheduler replaces 18 global state C.M.L with new valid state C.P, resulting in a new global states table 25.

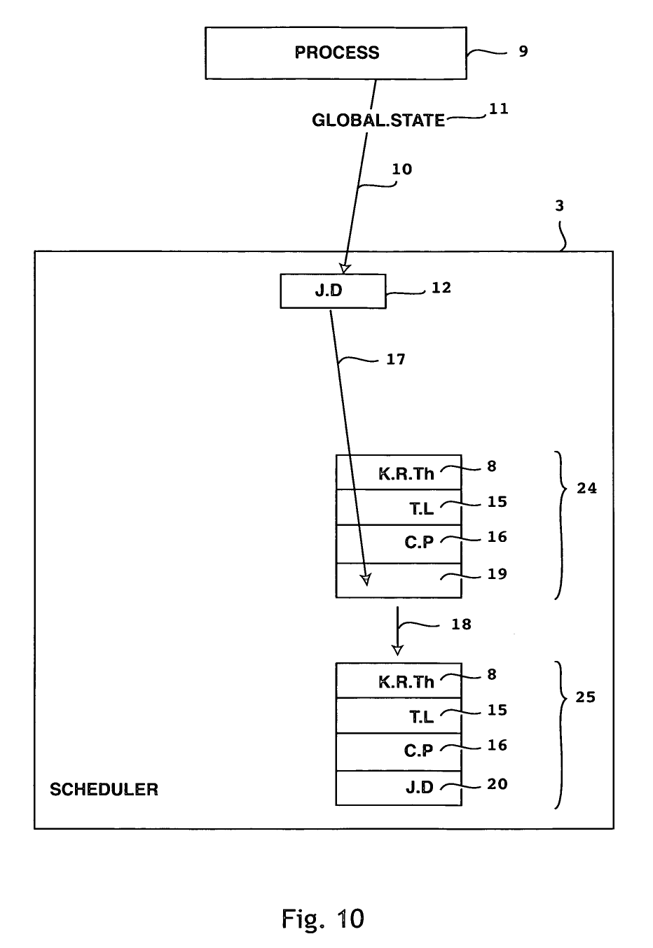

Referring to FIG. 10 the addition of a new global state is depicted. A process 9 makes available 10 data 12 containing a valid global state. The state does not share a root with any other existing valid global states 8, 15, 16. Thus, the scheduler extends the global states table 19 in memory 24, resulting 18 in a new extended global states list 25.

The present invention allows central monitoring and management of the modules and their communication, in the manner that will now be explained. A monitoring application can be connected to a central scheduler. In a preferred embodiment this application is a web browser or specially designed program. The monitoring program, also called monitor, allows a human user to view and control various aspects of the system.

The monitor allows a user to view:

(a) which central schedulers are available.

(b) data that has appeared and been transmitted on the information channels.

(c) the processes and information related to them.

(d) registration requests.

The monitor allows a user to:

(a) change the validity of global states.

(b) originate and transmit data.

(c) change registration requests.

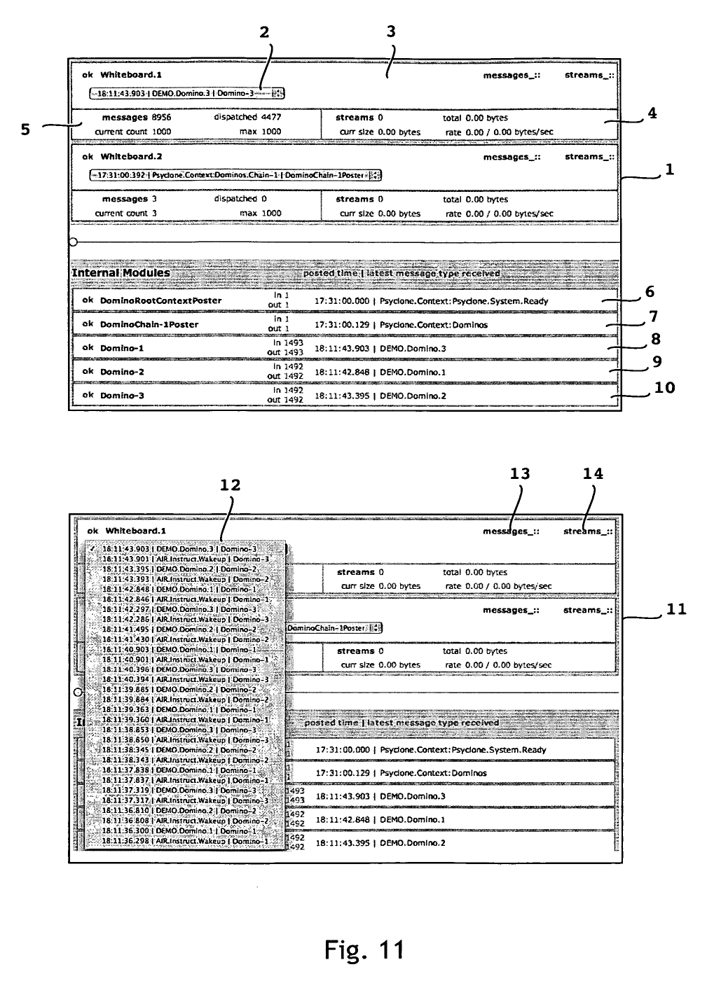

Referring to FIG. 11, a panel 1 contains elements that allow the user to view the most recently originated or transmitted data 2 for a scheduler 3. An area shows statistics about streaming data for a scheduler 4 and statistics for messages on that scheduler 5. Information about the modules 6, 7, 8, 9, 10 is also listed, including their most recently received data. In this case the modules are included in an executable that holds both schedulers and modules; modules are dynamically loaded libraries. The same panel 11 provides access to the history of transmitted data, messages in this case, in a drop-down interface 12. Links 13, 14 provide more detailed information about the schedulers and the data.

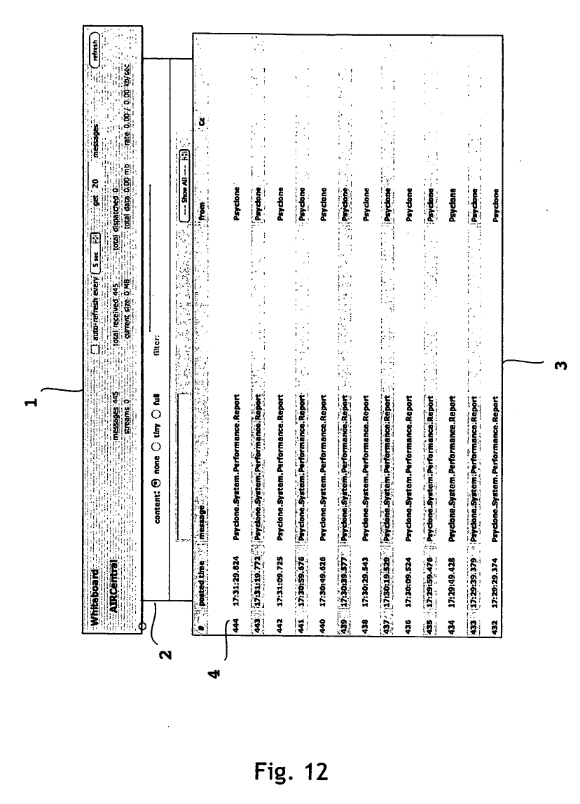

Referring to FIG. 12, a set of messages can be seen listed for a particular scheduler. Main information about the scheduler is listed at top 1. A filter 2 allows the user to select which data appears in the section below 3; each message occupies one line 4 in this implementation.

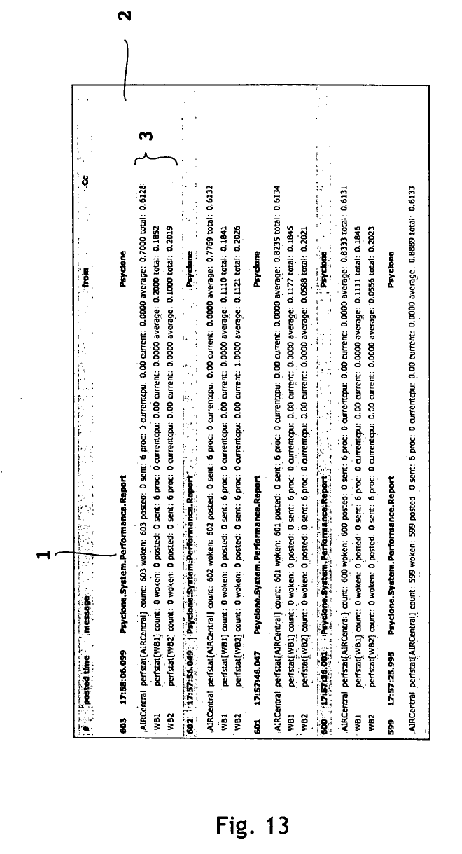

Referring to FIG. 13, the message in line 2 represents data transmitted on channel Psyclone.System.Performance.Report 1; a drop-down box below the line 3 shows additional detail about the message. Clicking on the message channel 1 will open up an even more detailed view (not shown) about the message itself.

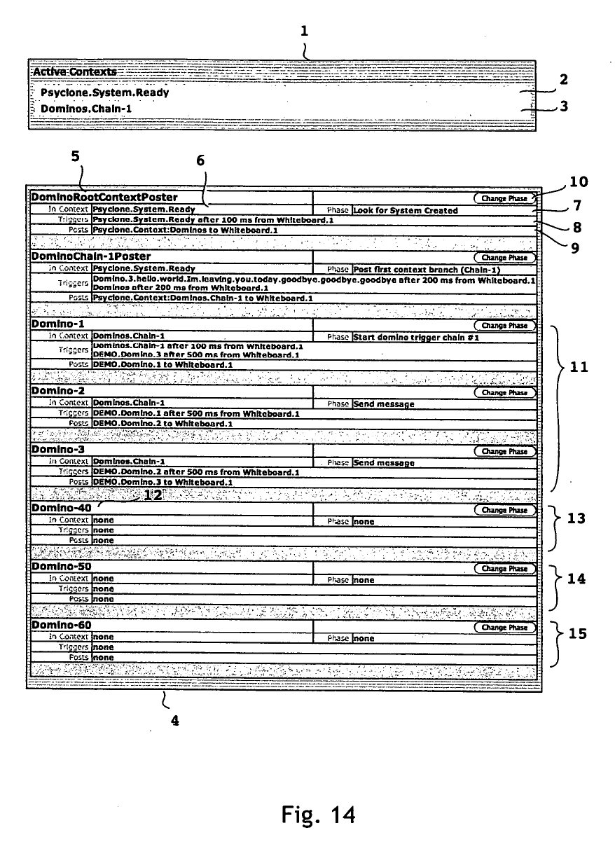

Referring to FIG. 14, a view of the currently valid global states is shown in box 1; the valid states in this example are Psyclone.System.Ready 1 and Dominos.Chain-1 2. Panel 4 shows a list of all modules that have registered with any one of the schedulers. At the top is the module called DominoRootContextPoster 5. The global state (called “context” here) it has registered for is called Psyclone.System.Ready 6. To switch this module to the next executable task manually, the user can click the button labeled “Change Phase” 10. Each line 7, 8, 9 shows different information about the module. Line 7 shows the current global state that makes this module active and the current executable task that is relevant. Line 8 shows the information channel that the module is listening to. Line 9 shows the information channel that the module will originate data on, if it were to do so. The modules that are currently active are listed as well 11. Module Domino-40 12 is not active because its global state is not valid.

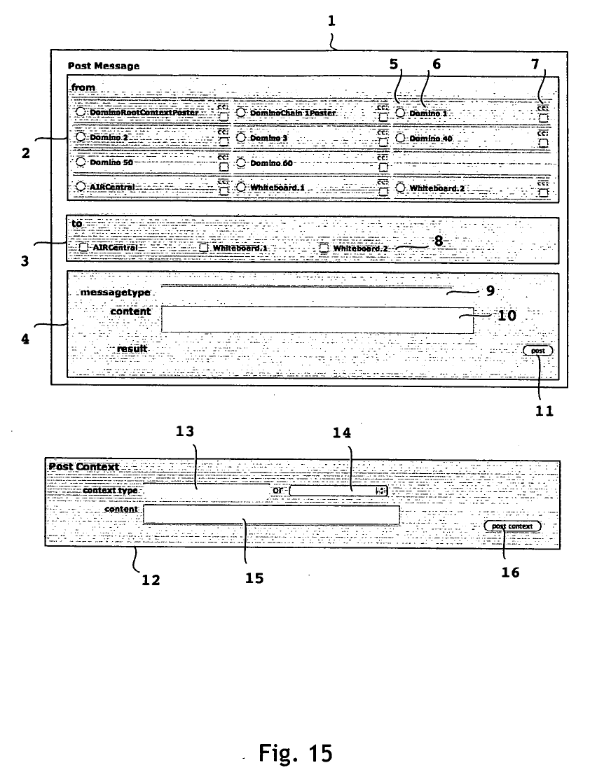

Referring to FIG. 15, a set of panels 1 allows a user to originate and transmit messages. Panel 2 allows the selection of who is listed as the originator of the message (done by selecting one of the selectors, e.g. 5), and which module(s) should get the message by default, whether they are registered for their information channel or not. For example, selecting 5 will originate a message that is marked as coming from a module called Domino-1 6; selecting the box 7 in the same line will make that module receive a copy of that same message. Panel 3 allows the user to select which scheduler should receive the message 8. Panel 4 allows the user to specify the name of the information channel 9, the content of the message 10, if any, and then to originate (send) 11 the message to the scheduler selected. Panel 12 allows a user to originate messages that change global states from valid to invalid, add a new valid state or make a currently invalid state valid. The information channel for this is specified in field 13. An optional drop-down 14 menu allows a selection from a set of known global states. Content, if any, goes in field 15. To originate (send) the message the user presses the button 16.

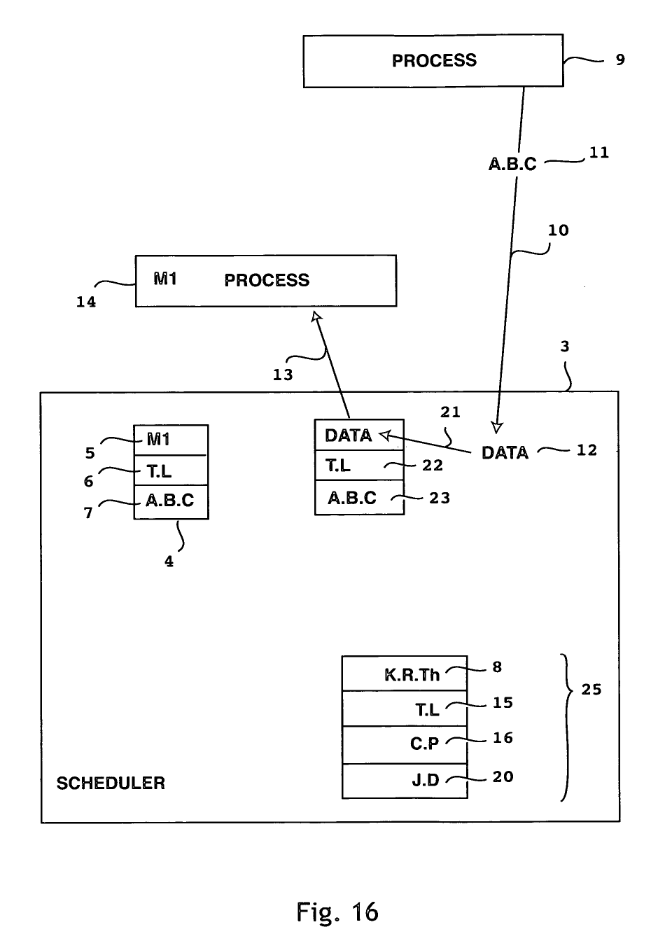

Referring to FIG. 16 a process 9 originates data 12 on information channel A.B.C 11 and sends it to a scheduler 3. The scheduler 3 determines that process M1 14 is registered 4 for data on channel A.B.C 7 and it's listed global state T.L 6, which is currently valid 15 in the list of global states 25. The scheduler will put data in a new “wrapper” 21, and adds the relevant global state 22 and the information channel that this data originated on 23, and transmit the new wrapper 13 to the process 14.

We claim:

1. A computer software tool for designing a software architecture, the tool comprising:
a plurality of data channels;
a plurality of global states; and
a software architecture maintainer;
wherein the maintainer communicates with a plurality of modules using the plurality of data channels and stores global states data;
wherein a module only receives data via a data channel for which the module has registered and wherein one or more of the global states is relevant to the module; and
whereby the software tool enables behavior modification of the module during runtime of the module.

2. A claim as recited in claim 1 wherein the module has one or more performable tasks, wherein a task is completed without knowledge of or intervention by the software architecture maintainer.

3. A claim as recited in claim 1 wherein the software architecture maintainer can be instructed to manage a first module by one of a human being, a second module, and any non-module entity having a communication means with the software architecture maintainer.

4. A claim as recited in claim 1 wherein the software architecture maintainer is informed of a global state of the module but will communicate with the module only if the global state is valid.

5. A claim as recited in claim 1 wherein the software architecture maintainer receives data on a data channel in a first format and transmits the data to the module on the data channel in a second format, wherein the module subscribes to receive data on the data channel.

6. A claim as recited in claim 1 wherein the module subscribes with the maintainer and whereby the module can alter subscriptions during runtime of the module.

7. A claim as recited in claim 1 wherein the module subscribes with the maintainer and whereby the subscription specifies at least one global state and at least one data channel.

8. A claim as recited in claim 7 wherein a global state listed in a registration is used for grouping a plurality of performable tasks and for grouping a plurality of data channels.

9. A claim as recited in claim 6 wherein altering subscriptions entails one of changing a global state only, changing a data channel only, and changing a global state and a data channel.

10. A claim as recited in claim 6 wherein the module performs a complete subscription with the software architecture maintainer at initial execution, thereafter the maintainer is able to independently manage execution of the module.

11. A claim as recited in claim 6 wherein the module performs a plurality of incremental subscriptions with the software architecture maintainer during module runtime.

12. A claim as recited in claim 1 wherein a global state is used for grouping a plurality of performable tasks and for grouping a plurality of data channels.

13. A method of executing a process in a software architecture, the method comprising:
subscribing with a system architecture maintainer, wherein a process informs the maintainer of one or more relevant global states and one or more named data channels;
receiving data from the system architecture maintainer only on a named data channel; and
performing executable tasks independent of the system architecture maintainer.

14. A claim as recited in claim 13 wherein subscribing with a system further comprises storing a subscription in a global file.

15. A claim as recited in claim 14 wherein the global file enables a designer of the software architecture to set up a registration in a complete manner or in an incremental manner, before the software architecture starts execution.

16. A method of managing a software architecture, the method comprising:
maintaining a first data relating to a plurality of global states;
maintaining a second data on validities of global states in the plurality of global states;
receiving an instruction from a module relating to a next executable task as specified in a module registration, the next executable task being known to a software architecture maintainer; and
maintaining a third data on a global state relevant to the module and at least one named data channel that is subscribed to by the module.
